(19) United States
(12) Patent Application Publication
(10) Pub. No.: US 2019/0024851 A1
(43) Pub. Date: Jan. 24, 2019

(54) TROFFER RETROFIT KIT

(71) Applicant: KANGHONG ZHANG, SANTA FE SPRINGS, CA (US)

(72) Inventor: KANGHONG ZHANG, SANTA FE SPRINGS, CA (US)

(21) Appl. No.: 16/036,193

(22) Filed: Jul. 16, 2018

Related U.S. Application Data
(60) Provisional application No. 62/535,414, filed on Jul. 21, 2017.

(51) Int. Cl. F21K 9/275; F21S 8/02; F21V 21/03

(52) U.S. Cl. CPC F21K 9/275; F21Y 2103/20; F21V 21/03; F21S 8/026

(57) ABSTRACT

The troffer retrofit kit has a first housing formed in a planar shape. A second housing is formed in a planar shape and the second housing opposes the first housing. A middle panel has a middle panel first side and a middle panel second side. The middle panel first side is parallel to an inside edge of the first housing. The middle panel second side is parallel to an inside edge of the second housing. A first end panel connects to the first housing at a first housing first end, connects to the second housing at the second housing first end, and connects to the middle panel at a middle panel first end.

This application is a non-provisional of inventor Kanghong Zhang's U.S. provisional application 62/535,414 filed Jul. 21, 2017, also entitled Troffer Retrofit Kit, the disclosure of which is incorporated herein by reference.

### FIELD OF THE INVENTION

The present invention is in the field of lighting retrofit kits.

### DISCUSSION OF RELATED ART

A wide variety of different retrofit kits have been made before in the industry. However, these retrofit kits vary in terms of ease of assembly as they have different assembly methods and configurations.

Inventor Saturnino Oquendo, Jr. describes a lighting system in US Patent publication number US2010/0277934A1 entitled the Retrofit Kit And Light Assembly For Troffer Lighting Fixtures that was published on Nov. 4, 2010. The abstract describes, “A retrofit kit and light assembly is provided for retrofitting an existing troffer lighting fixture having four side walls defining a recessed cavity. The retrofit kit comprises a plurality of interlocking frame members, a reflector, and a lens. The plurality of interlocking frame members are configured to interconnect with one another to form a rectangular shell with an open face pointing downwards. The reflector is configured to interconnect with respective ones of the plurality of interlocking frame members and the lens is configured to interconnect with the reflector. Each of the plurality interconnecting frame members comprises a bottom portion and an angled body portion such that the rectangular shell may be formed by the interconnecting frame members and fits within the recessed cavity of the existing troffer lighting fixture when assembled.”

Inventor Russell A. Price describes a lighting system in US Patent publication number US2015/0267873A1 entitled the Retrofit Kit For Drop Ceiling Lighting Fixtures that was published on Sep. 24, 2015. The abstract describes, “A retrofit kit for drop ceiling lighting fixtures and a method of retrofitting drop ceiling lighting fixtures are provided. The retrofit kit includes a pair of adapter brackets configured to be mounted to opposing sides of a drop ceiling fixture, and a door-light assembly configured to be pivotally coupled to one adapter bracket, and to be latched to the other adapter bracket.”

### SUMMARY OF THE INVENTION

The troffer retrofit kit has a first housing formed in a planar shape. A second housing is formed in a planar shape and the second housing opposes the first housing. A middle panel has a middle panel first side and a middle panel second side. The middle panel first side is parallel to an inside edge of the first housing. The middle panel second side is parallel to an inside edge of the second housing. A first end panel connects to the first housing at a first housing first end, connects to the second housing at the second housing first end, and connects to the middle panel at a middle panel first end.

A second end panel connects to the second housing at a second housing first end, connects to the second housing at the second housing second end, and connects to the middle panel at a middle panel second end. A light is mounted to the middle panel and a plastic translucent or transparent lens is mounted over the light. The light can be a light-emitting diode array.

The troffer retrofit kit also preferably further includes a first middle latch connecting the first housing to the middle panel; and a second middle latch connecting the first housing to the middle panel. Additionally, a first side panel latch connects the first side panel to the middle panel; and a second side panel latch connects the second side panel to the middle panel.

A first side panel latch slot opening receives a latch hook of the first side panel latch. A first side panel latch has a first side panel latch latch body, and the first side panel latch latch body has a latch hook, a latch handle, and a latch pivot. The pivot is preferably a riveted connection made on the middle panel. The first middle latch and the middle latch are made with latch bodies. The first middle latch has a first middle latch latch body, and the second middle latch has a second middle latch latch body. The first middle latch latch body has a latch hook, a latch handle, and a latch pivot, and the second middle latch latch body also has a hook, a latch handle, and a latch pivot. The latch pivots are riveted connections that are preferably made on the middle panel. In this way, all of the latch pivots are mounted on the middle panel by riveting.

### BRIEF DESCRIPTION OF THE DRAWINGS

FIG. 1 is a prior art exploded view of a prior art retrofit kit.

FIG. 2 is a bottom view of the retrofit kit.

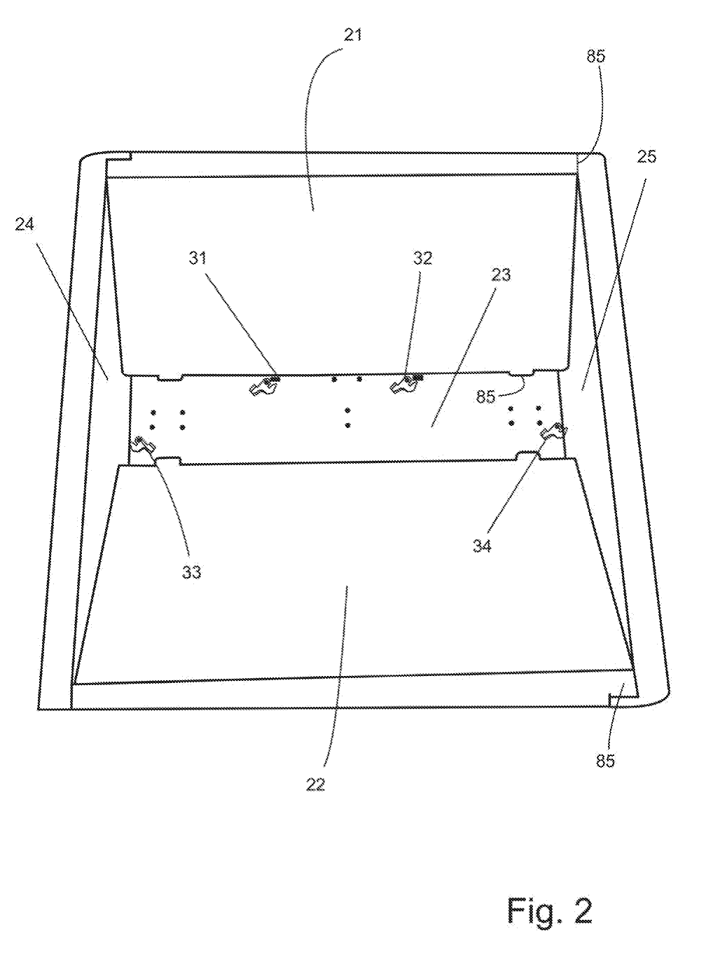

FIG. 3 is a close-up view of a side panel latches of the retrofit kit.

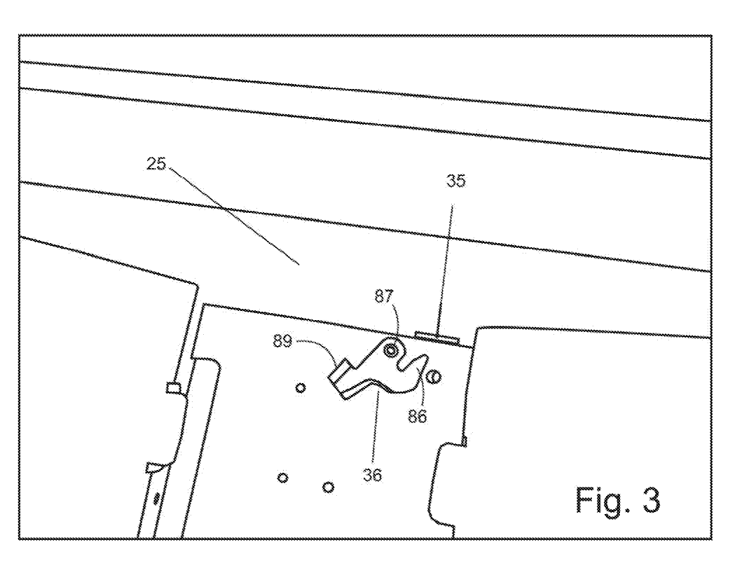

FIG. 4 is a close-up view of the middle latches of the retrofit kit.

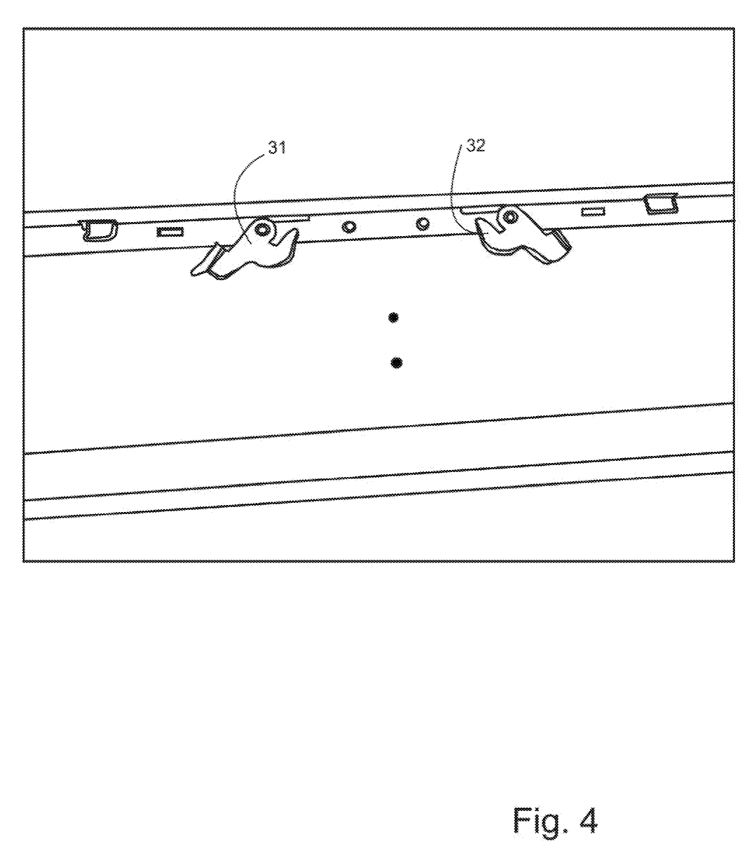

The following call out list of elements can be a useful guide in referencing the element of the drawings.
21 First Housing
22 Second Housing
23 Middle Panel
25 First End Panel
26 Second End Panel
31 First Middle Latch
32 Second Middle Latch
33 Second Side Panel Latch
34 First Side Panel Latch
35 First Side Panel Latch Slot Opening
36 First Side Panel Latch Latch Body
41 First Middle Latch Slot Opening
42 First Middle Latch Latch Body
43 Second Middle Latch Slot Opening
44 Second Middle Latch Latch Body
50 Lens
51 Middle Panel First Side
52 Middle Panel Second Side
53 Inside Edge Of The First Housing
54 Inside Edge Of The Second Housing
55 First Housing First End
56 Second Housing First End
57 Middle Panel First End
58 First Housing Second End
59 Second Housing Second End
60 Middle Panel Second End
85 Tab And Slot Connection
86 Latch Hook
87 Latch Pivot
88 Light Element
89 Latch Handle

### DETAILED DISCUSSION OF THE PREFERRED EMBODIMENT

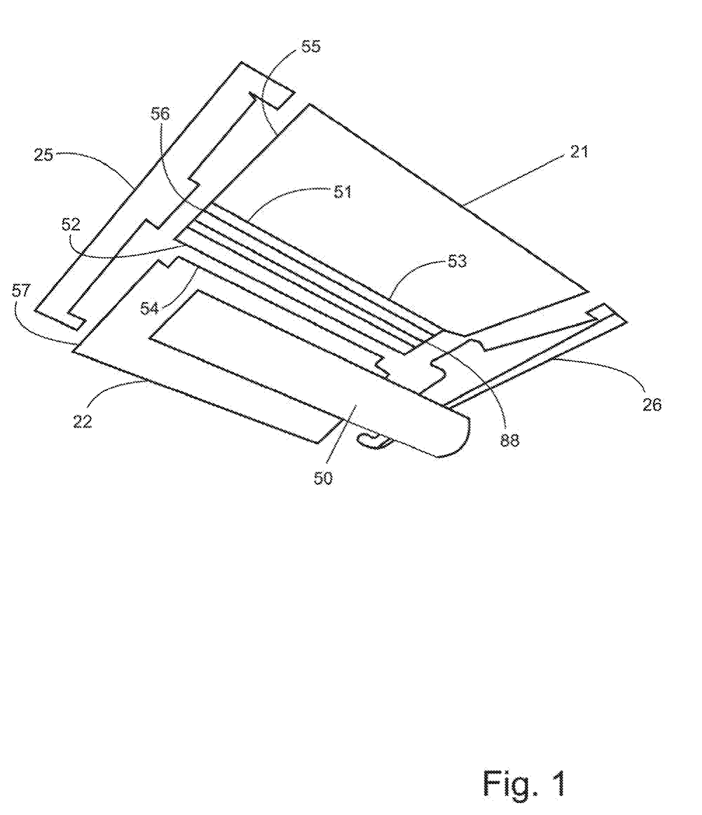

The present invention has a first housing 21, a second housing 22, a first end panel 25 and a second end panel 26 similar to the prior art of FIG. 1. The present invention has an improved connection method using four latches. A pair of middle latches secures the panel middle portion and a pair of side latches secures the side panels, namely the first end panel 25 and the second end panel 26. The various housing panels and end panels serve to hold the light element 88 in place over the previous drop ceiling fixture so as to cover the old fixture with a new troffer retrofit kit thereby retaining the upper housing of the old troffer. This allows rapid installation for upgrading to new look without making structural changes.

The first housing 21 connects to the second housing 22. The second housing 22 has a middle panel that connects to the first housing 21. A first middle latch 31 and a second middle latch 32 are riveted to the panel so that they rotate. The latches have a latch hook that engage a slot opening. The second side panel latch 33 and the first side panel latch 34 provide a way of connecting the side panels. The second side panel latch 33 and the first side panel latch 34 are riveted to the second housing 22 at the middle panel 23 of the second housing 22.

The first side panel latch 34 has latch body 36 that has a hook end that engages a first side panel latch slot opening 35. The second side panel latch 33 has the same structure and operation as the first side panel latch 34.

The first side panel latch slot opening 35 receives the hook end of the first side panel latch latch body 36. The first middle latch slot opening 41 receives the hook end of the first middle latch latch body 42. The second middle latch 32 has a second middle latch slot opening 43 receiving a hook end of a second middle latch latch body 44.

The lens 50 covers the middle panel 23 and the latches and latch openings. The lighting elements such as light emitting diodes arrays are mounted to the middle panel 23. The middle panel 23 has a middle panel first side 51 that is parallel to an inside edge of the first housing 53. The middle panel 23 also has a middle panel second side 52 that is parallel to the an inside edge of the second housing 54.

The first end panel connects to the first housing, the second housing, and the middle panel on a first housing first end 55, a second housing first end 56 and a middle panel first end 57. Similarly, the second end panel connects to the first housing, the second housing, and the middle panel on a first housing second end 58, a second housing second end 59 and a middle panel second end 60.

Optionally, the second panel 22 and the middle panel 23 can be made of the same sheet of metal by bending the sheet of metal, or optionally the second panel 22 and the first panel 21 can be made of the same sheet of metal by bending the sheet of metal.

Other mechanical connections can be made by tab and slot connections 85. Tab and slot connections 85 occur when a planar member is formed with a tab to connect to an adjacent planar member formed with a slot. For example, a plurality of tab and slot connections 85 can connect the middle panel 23 to the first panel 21 or the second panel 22. Additionally, the tab and slot connection 85 method can be used to connect the first and second end panels to the first housing, the second housing and the middle panel.

The latch hook 86 extends into the troffer such as through a first side panel latch slot opening 35. The latch pivot 87 is preferably riveted to the middle panel 23 to provide a swivel connection. The light element 88 is mounted to the middle panel 23. The latch handle 89 is a bent metal extension of the latch and provides a 90° bend so that when the latch hook 86 rotates into the engaged position from the disengaged position, the latch handle 89 will be parallel to a plane of the first housing 21, second housing 22, first end panel 25, or the second end panel 26.

The key feature of the present invention is that the configuration keeps all of the latch hooks on the middle panel so that a user need not shift weight or posture on a ladder during installation. Although the middle panel can be integrally formed with any of its adjacent panels, preferably, it is formed with the first housing.

1. A troffer retrofit kit comprising:
a. a first housing formed in a planar shape;
b. a second housing formed in a planar shape, wherein the second housing opposes the first housing;
c. a middle panel with a middle panel first side and a middle panel second side, wherein the middle panel first side is parallel to an inside edge of the first housing, wherein the middle panel second side is parallel to an inside edge of the second housing;
d. a first end panel connecting to the first housing at a first housing first end, connecting to the second housing at the second housing first end, and connecting to the middle panel at a middle panel first end;
e. a second end panel connecting to the second housing at a second housing first end, connecting to the second housing at the second housing second end, and connecting to the middle panel at a middle panel second end;
f. a light mounted to the middle panel; and
g. a lens mounted over the light.

2. The troffer retrofit kit of claim 1, further including:
a. a first middle latch connecting the first housing to the middle panel; and
b. a second middle latch connecting the first housing to the middle panel.

3. The troffer retrofit kit of claim 1, further including:
a. a first side panel latch connecting the first side panel to the middle panel; and
b. a second side panel latch connecting the second side panel to the middle panel.

4. The troffer retrofit kit of claim 3, further including: a first side panel latch slot opening receiving a latch hook of the first side panel latch.

5. The troffer retrofit kit of claim 1, further including: a first side panel latch having a first side panel latch latch body, wherein the first side panel latch latch body has a latch hook, a latch handle, and a latch pivot.

6. The troffer retrofit kit of claim 5, wherein the latch pivot is a riveted connection made on the middle panel.

7. The troffer retrofit kit of claim 1, further including: a first middle latch and a second middle latch, wherein the first middle latch has a first middle latch latch body, and wherein the second middle latch has a second middle latch latch body, wherein the first middle latch latch body has a latch hook, a latch handle, and a latch pivot, wherein the second middle latch latch body has a hook, a latch handle, and a latch pivot.

8. The troffer retrofit kit of claim 7, wherein the latch pivots are riveted connections made on the middle panel.

9. The troffer retrofit kit of claim 8, further including:
a. a first middle latch connecting the first housing to the middle panel; and
b. a second middle latch connecting the first housing to the middle panel.

10. The troffer retrofit kit of claim 8, further including:
a. a first side panel latch connecting the first side panel to the middle panel; and
b. a second side panel latch connecting the second side panel to the middle panel.

11. The troffer retrofit kit of claim 10, further including: a first side panel latch slot opening receiving a latch hook of the first side panel latch.

12. The troffer retrofit kit of claim 8, further including: a first side panel latch having a first side panel latch latch body, wherein the first side panel latch latch body has a latch hook, a latch handle, and a latch pivot.

13. The troffer retrofit kit of claim 12, wherein the latch pivot is a riveted connection made on the middle panel.
